(19) United States
(12) Patent Application Publication
(10) Pub. No.: US 2012/0118124 A1
(43) Pub. Date: May 17, 2012

(54) Guitar pitch stability system with saddle clamps

(76) Inventor: John W. Hamilton, Rock Hill, NY (US)

(21) Appl. No.: 12/927,358

(22) Filed: Nov. 12, 2010

(51) Int. Cl. G10D 3/04

(52) U.S. Cl. 84/298

(57) ABSTRACT

This invention improves guitar pitch stability and requires no modifications to a guitar or any of its parts. It is a low profile design which pertains in particular to Fender Stratocasters or any electric guitars with a similar bridge plate and tone block design. This invention does basically two things. First, the guitar strings are rerouted giving a much softer string bend past the string saddles (similar to Gibson guitars) which significantly reduces string drag (friction) at the saddles. After “dive-bombing” downward or going upward in pitch via the tremolo arm (as with a Stratocaster), the guitar returns to its original pitch when the tremolo arm is released. Second, readjustable saddle clamps are used which hold and lock all six string saddles together in position and to the bridge plate after string height and intonation adjustments have been made.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

This invention pertains in particular to Fender Stratocasters or any electric guitars with a similar bridge plate design. Regarding prior art, these guitars are traditionally strung by having the strings make nearly a 90 degree bend as they go over the string saddles and then terminate inside the guitar at either the tone block or the guitar body. As such, there is significant string drag (friction) at the saddles which causes pitch stability problems. The following paragraph in particular refers to Stratocaster type guitars.

For the case where the guitar bridge has been setup in the traditional manner, one can only use the tremolo arm to go downward in pitch. While “dive-bombing” downward in pitch via the tremolo arm, the guitar strings relax in tension and tend to creep past the string saddles and down back into the interior of the guitar. When the tremolo arm is then released, the result is that the guitar goes and stays out of tune to a higher pitch (i.e. sharp). The same is true if the guitar has been setup in a “floating bridge” configuration. To get the guitar back to its original proper pitch, one has to do string bends upward in pitch and then release them to get the strings back to where they were with respect to the saddles before the tremolo arm was used. This problem exists even if the strings are lubricated at the string saddles according to manufacturer's recommendations.

### BRIEF SUMMARY OF THE INVENTION

The object of this invention is to effectively solve the pitch stability problems as previously described in prior art by significantly reducing string drag (friction) at the saddles. After use and then release of the tremolo arm, with this invention the guitar returns to its proper pitch. It requires no modifications to a guitar or any of its parts and pertains in particular to Fender Stratocasters or any electric guitars with a similar bridge plate design. Note that the newer style rectangular-shaped string saddles are here required (not the vintage string saddles).

With this invention, the guitar strings are rerouted giving a much softer string bend past the string saddles (similar to Gibson guitars). This is accomplished by removing the intonation adjusting screw and spring from each of the six string saddles. The guitar is then restrung with each string first going through the corresponding hole in the bridge plate (on the top of the guitar). The string then goes through the hole in the string saddle (which previously held the intonation adjusting screw). The string then sits in the groove of the string saddle and the other end of the string is terminated as before at the tuning peg of the guitar neck. At this point, the string saddles are held in position by only the guitar strings.

Key to this invention are the two simple readjust able string saddle clamps (later described in detail) which hold and lock the string saddles together in position after string height and intonation adjustments have been made. With all six of the string saddles clamped together as a unit and the guitar tuned to pitch, they will not move (true even if a string breaks). Both the guitar strings and the saddle clamps hold the saddles in position. For this reason, if the guitar needs to be restrung, it should be done so one string at a time.

This invention has two other noteworthy features. First, it is a low-profile design and as such does not change the “feel” of the guitar. Second, the saddle clamps hold all six string saddles together as a unit and therefore level with respect to the bridge plate (in accordance with the string saddle manufacturer's recommendations).

### DESCRIPTION OF DRAWINGS

FIG. 1 is a simplified depiction of a Fender Stratocaster electric guitar showing the implementation of this invention.

FIG. 2 is an exploded view of the guitar bridge plate and tone block showing both the assembly of the components of this invention and sample guitar string rerouting.

FIG. 3 is a close-up depiction of this invention clamping all six string saddles.

FIG. 4 is a close-up view of the saddle clamp which contacts the lower E string saddle.

### DETAILED DESCRIPTION OF THE INVENTION

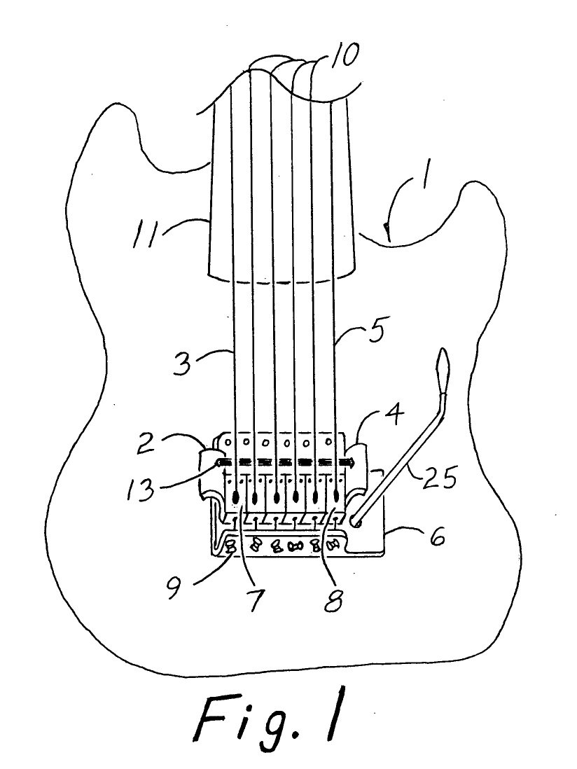

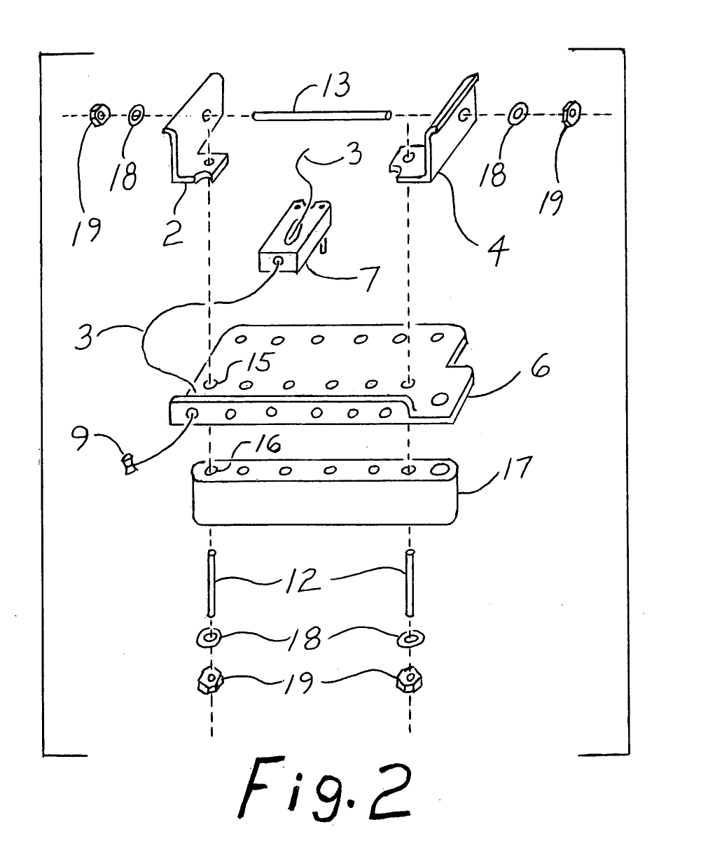

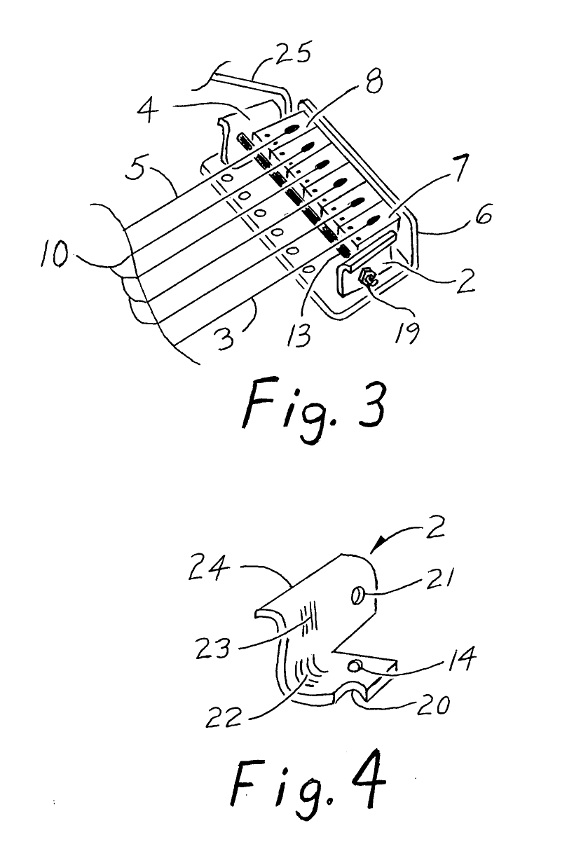

Items in this section are enumerated in conjunction with items depicted in FIG. 1 through FIG. 4.

FIG. 1 is a simplified version of a Stratocaster guitar 1 (set to standard tuning) with tremolo arm 25. There is enough detail to show three of the invention components: the saddle clamp 2, the saddle clamp 4, and the clamp-connecting piece of threaded rod 13 (for clarity shown as a solid black horizontal rod which resides underneath the guitar strings). As previously described in paragraph [08] of the BRIEF SUMMARY OF THE INVENTION section, the guitar strings (lower E string 3, upper E string 5, and the middle four strings 10) are rerouted through the intonation holes in the top of the bridge plate 6 and the six string saddles (the lower E string saddle 7, the upper E string saddle 8, and the middle four string saddles (not enumerated due to excessive diagram clutter)). Note in particular the enumeration of the ball end 9 of the lower E string 3 (the upper E string 5 and the middle four guitar strings 10 have their ball ends terminated in a similar way at the bridge plate 6). The other end of the six guitar strings 3, 5, and 10 are terminated in the usual way out on the tuning pegs (not shown) of the guitar neck 11.

The following in particular refers to Stratocaster type guitars. With the intonation adjustment saddle screws removed, it is necessary to hold all of the string saddles in position with two saddle clamps 2 and 4. One clamp 2 contacts one side of the string saddle 7 used for the lower E string 3, the other clamp 4 contacts one side of the string saddle 8 used for the upper E string 5. What follows is derived from a hand-built working prototype of this invention.

The clamps 2 and 4 are each anchored to the bridge plate 6 by the use of a piece of 4-40 clamp-mounting threaded rod 12 (typical for both clamps). One end of this threaded rod is secured to each clamp via a threaded hole 14 in each clamp (typical). For the clamp 2 used on the lower E string saddle 7, the threaded rod 12 goes down through the vacant hole 15 in the bridge plate 6 and the vacant hole 16 in the tone block 17 (these holes 15 and 16 were previously occupied by the lower E string 3). Underneath the guitar 1, the other end of the threaded rod 12 is secured to the tone block 17 via a washer 18 (typical elsewhere) and hex nut 19 (typical elsewhere). In a similar way, the saddle clamp 4 for the upper E string saddle 8 is mounted to the bridge plate 6 (in the vacant holes of the bridge plate 6 and tone block 17 previously occupied by the upper E string 5). With the two saddle clamps 2 and 4 installed via their threaded rods 12 and their hex nuts 19 snugly tightened, these clamps can pivot slightly. With this invention, the ball end of the guitar strings no longer terminate in the tone block 17, but rather out on the bridge plate 6 on top of the guitar 1.

The clamp-connecting piece of 4-40 threaded rod 13 should now loosely be installed through the remaining hole 21 (typical) in each of the saddle clamps 2 and 4. A washer 18 and hex nut 19 are used to secure the threaded rod 13 at either end. Note that the low profile design is such that this rod sits underneath the guitar strings.

The guitar 1 should now be loosely strung (ball-ended or bullet-ended strings can be used), with each string 3, 5, and 10 first going through their respective hole in the bridge plate 6, then the hole in their respective string saddle (e.g. 7 and 8), each string then sitting in its groove of the string saddle, and finally terminating at the tuning peg of the guitar neck 11. With all six string saddles installed, the clamp-connecting piece of threaded rod 13 should be tightened snug at this point to position the string saddles flush with each other. The string saddle height and intonation adjustments can now be made with the guitar 1 tuned to proper pitch. To complete the setup: tighten the two clamp-mounting threaded rods 12 (one for each of the clamps 2 and 4) at the tone block 17 (from underneath the guitar), and then tighten the clamp-connecting piece of threaded rod 13. The tightened threaded rod 13 provides the clamping force for the two saddle clamps 2 and 4 against the cluster of all six string saddles.

For what follows in the rest of this section, refer to FIG. 4 regarding specific details of the saddle clamp 2 which contacts the lower E string saddle 7. Note that the two saddle clamps (2 and 4) are effectively mirror images of one another (so this discussion is applicable to both clamps). The surface of the clamps 2 and 4 which contact the string saddles 7 and 8 should be milled, molded, or shaped to provide a true 90 degree corner 22 (underneath the saddle) and a true flat surface of contact 23 between the clamp and the saddle. This is necessary to prevent the string saddles from lifting upward when they are clamped. Note that when the clamps are fabricated, if the correct spacing is used with respect to the clamp mounting hole 14 and the surface of contact 23, then the saddle clamps 2 and 4 will engage the string saddles flush when the clamps are tightened.

The saddle clamp upper lip 24 should be there to provide additional strength where the clamp-connecting piece of threaded rod 13 acts as the clamping mechanism. The lip 24 should be outward and away from the string saddles to allow for access to the string height adjustment set screws of the saddles. Alternately, thicker, stronger material could be used for the clamps to eliminate this lip.

The prototype saddle clamps 2 and 4 were built from 1/16 inch thick stainless steel. They could be constructed of even thicker material, and their thickness would still not interfere with the position of the string saddles from underneath (with the guitar strings now going through the saddles, they tend to sit up higher at the end furthest away from the saddle string height adjusting set screws).

The bottom mounting surface of the saddle clamps 2 and 4 have a rounded corner cut-out 20. This is necessary so that the bottom mounting surface of each clamp is flush with the bridge plate 6. Otherwise, there would be interference between the bottom surface of the clamps and the large counter-sunk flat head tone block mounting screws in the bridge plate.

For the anchor points of the saddle clamps 2 and 4, instead of 4-40 clamp-mounting threaded rod 12, a 4-40 button-head (low profile) screw of 1.75 inch approximate length could be used (eliminating a washer 18 and a hex nut 19 for each).

Note that for the clamp-connecting piece of threaded rod 13, a 4-40 socket cap head screw of 3.0 inch approximate length could be used (eliminating a hex nut 19).

1. A guitar pitch stability system which is applicable to Fender Stratocaster guitars or any electric guitars with a similar bridge plate design, comprising: the means to have the guitar restrung which significantly reduces the angle of deflection of the guitar strings as they go over the string saddles, thereby reducing the string drag (friction) at the saddles and improving pitch stability.

2. A guitar pitch stability system as defined in claim 1 further comprising:
guitar restringing detail here described with one end of each string terminating at the respective tuning peg at the head of the guitar neck, then contacting the groove in the guitar nut and passing over the fret board, then passing over and contacting the groove in the string saddle, then passing through and possibly contacting the threaded hole in the string saddle which previously held the intonation adjusting screw (intonation screw and spring have been removed), then passing through the corresponding hole (which previously held the head of the aforementioned intonation screw) in the top of the bridge plate, with the ball (or bullet) end of the string terminating at the far side (away from the fret board) of the same corresponding hole in the top of the bridge plate (i.e. the ball (or bullet) end of the string terminates where the head of the intonation adjusting screw previously terminated).

3. A guitar pitch stability system as defined in claim 2 further comprising:
a pair of readjust able saddle clamps or a clamping mechanism which effectively holds all the string saddles together as a unit, with the mating surface of the first clamp (or first part of the clamping mechanism) contacting the exposed side of the string saddle used for the lower E string (standard tuning) and this clamp (or this part of the clamping mechanism) anchored to the bridge plate via mechanical attachment of this clamp (or this part of the clamping mechanism) to any combination of the following hardware, but not limited to: threaded rod, nuts, washers, machine screws, stand-offs, spacers, or brackets, which resides in the hole vacated by the lower E string in the bridge plate and the tone block (or any hole or combination of the holes vacated by the guitar strings in the bridge plate and the tone block); with the mating surface of the second clamp or second part of the clamping mechanism) contacting the exposed side of the string saddle used for the upper E string, and this clamp (or this part of the clamping mechanism) anchored to the bridge plate in a similar way as the first clamp (or first part of the clamping mechanism) here using the hole vacated by the upper E string in the bridge plate and the tone block.

4. A guitar pitch stability system as defined in claim 3 further comprising:
the aforementioned pair of saddle clamps or a clamping mechanism having either holes, grooves, slots, or any other such mechanical means to accept any of, but not limited to the following: threaded rod, nuts, washers, machine screws, stand-offs, spacers, or brackets; with this hardware serving to provide the clamp-to-clamp (or clamping mechanism) readjust able clamping force for all of the string saddles to hold them in position as a unit.

5. A guitar pitch stability system as defined in claim 4 further comprising:
in order to accommodate for different hole spacings in the bridge plate and the tone block between the lower E string and upper E string holes (standard tuning) (or any and all of the string holes) within the family of guitars to which this invention is applicable: a first option is to have pairs of saddle clamps (or a clamping mechanism) fabricated (with each pair (or clamping mechanism) having slightly different dimensions regarding the position of their mounting holes) to correspond to each of the possible aforementioned different hole spacings; a second option is to have one adjustable “global” pair of saddle clamps (or clamping mechanism) fabricated (to fit all of the possible hole spacings), with the optional use of shims to be placed between the mating surface of each saddle clamp (or clamping mechanism) and their respective outermost string saddle with which they are in contact.

6. A guitar pitch stability system as defined in claim 5 further comprising:
the following option (among possibly others) to provide support to the underside of the string saddles (at their end furthest away from the saddle string height adjusting set screws), and also to help hold them in position after string height and intonation adjustments have been made; whereby a first piece of sticky-back Velcro is added to the top of the bridge plate (i.e. under the string saddles), with then a second longer piece of one-wrap Velcro attached to the first piece, and the string saddles sitting on top of said second longer piece of Velcro, with then a third group of individual pieces of sticky-back Velcro with one piece each attached to the topside of each of the string saddles (at their end furthest away from the saddle string height adjusting set screws), thus allowing each end of the said second longer piece of Velcro to be wrapped around and across the top of the string saddles and contacting the third group of sticky-back Velcro.

7. A guitar pitch stability system as defined in claim 2 further comprising:
the mechanical means of implementing this invention to include the options of either not having to modify a guitar or any of its parts, or allowing for the modification or redesign of the string saddles and or the bridge plate whereby: the string saddles are each individually adjustable for string height and intonation, held in position with respect to each other and to the bridge plate, while still maintaining the end-to-end guitar restringing scheme described in claim 2.
